(19) United States
(12) Patent Application Publication
(10) Pub. No.: US 2003/0215070 A1
(43) Pub. Date: Nov. 20, 2003

(54) System for enhanced caller identification delivery

(76) Inventors: A. Akhteruzzaman, Naperville, IL (US); Paul Raymond Sand, Woodridge, IL (US); Claudis L. Young, Aurora, IL (US); Richard Grant Sparber, Wheaton, IL (US); Maureen Brigid Gallagher, Naperville, IL (US)

Correspondence Address: PATTON BOGGS, PO BOX 270930, LOUISVILLE, CO, 80027, US

(21) Appl. No.: 10/151,806

(22) Filed: May 20, 2002

(51) Int. Cl. H04M 1/64

(52) U.S. Cl. 379/88.19; 379/88.21

(57) ABSTRACT

The system for enhanced caller identification delivery extends the capabilities of existing caller ID systems by providing delivery of the caller ID data, received from the calling party's Local Exchange, to the called subscriber whether the called subscriber is located at their assigned telephone line or at another location. This system also provides the optional capability for the calling party to provide a brief message for transmission to the called subscriber along with the traditional caller ID data.

### FIELD OF THE INVENTION

This invention relates to telephone switching systems and to a caller ID system that provides additional options for the delivery of caller ID information to the called party.

### Problem

It is a problem in the field of telephone switching systems that the caller ID information is exclusively delivered to the called subscriber at their home location and cannot be accessed from another location or simultaneously delivered to multiple locations.

The subscriber lines in the Public Switched Telephone Network can be equipped with caller ID apparatus which functions, in response to an incoming call being placed to the called subscriber's telephone line, to provide the called subscriber, served by the telephone line, with an indication of the identity of a calling party. This apparatus and the corresponding information delivery service is typically termed “caller ID” and the data displayed to the called subscriber typically consists of the telephone number of the calling party and their name (if available). This caller ID data is originated by the Local Exchange that serves the calling party and is transmitted via a Signaling Network to the Local Exchange that serves the called subscriber's telephone line. The called subscriber receives the caller ID information and can receive the incoming call, if still ringing, decline to accept the call, if still ringing, or view a listing of incoming calls that arrived when the subscriber was not present to accept the incoming calls. In all of these cases, the subscriber must be physically present at their home location to view the caller ID data that is displayed on the caller ID apparatus.

This limitation is especially significant when the called subscriber is absent from their home location for an extended period of time or is awaiting incoming calls that require a rapid response. Thus, the present caller ID apparatus and associated service represent an advance over the prior service offerings where the identity of the calling party was unknown, but are subject to limitations that reduces their effectiveness.

### Solution

The above described problems are solved and a technical advance achieved in the art by the present system for enhanced caller identification delivery which provides delivery of the caller ID data, received from the calling party's Local Exchange, to the called subscriber whether the called subscriber is located at their assigned telephone line or at another location. This feature also includes the optional capability for the calling party to provide a brief message for transmission to the called subscriber along with the traditional caller ID data.

The system for enhanced caller identification delivery is optionally connected to an IP Network, such as the Internet, through an IP Network Interface to enable it to exchange messages with other Message Servers. A memory is used to store the caller ID data and to maintain a log of the caller ID data transfers that are described herein.

### BRIEF DESCRIPTION OF THE DRAWINGS

FIG. 1 illustrates in block diagram form the present system for enhanced caller identification delivery and an environment in which it is operational; and

FIG. 2 illustrates in flow diagram form the operation of the present system for enhanced caller identification delivery.

### DETAILED DESCRIPTION OF THE DRAWINGS

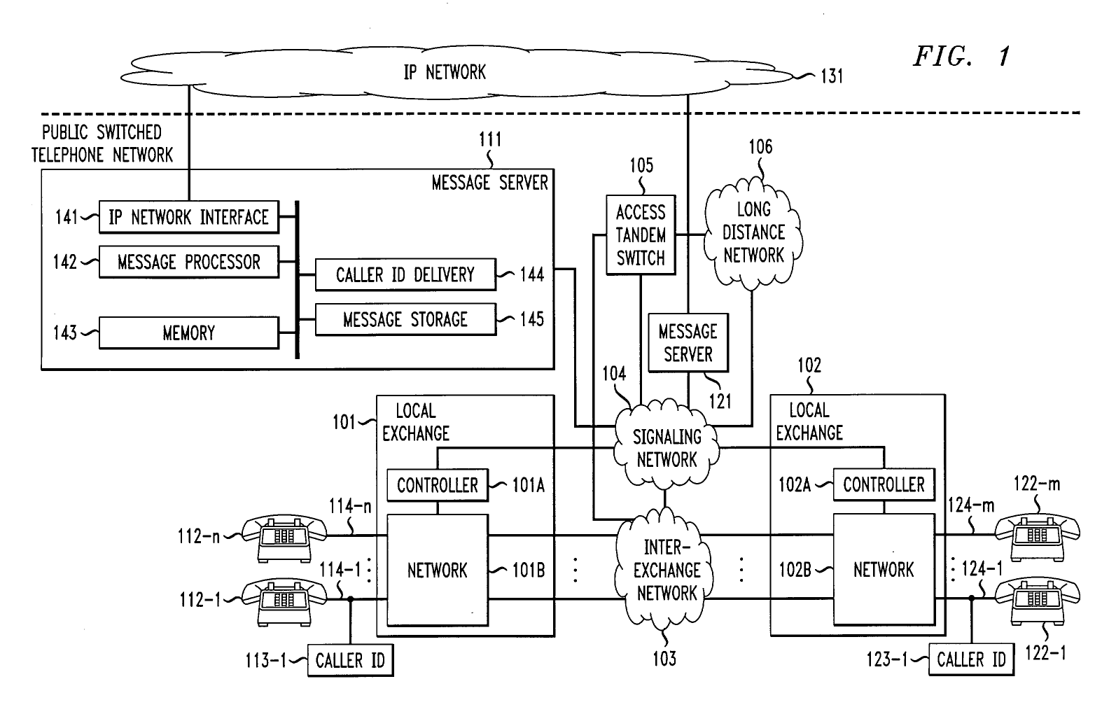

FIG. 1 illustrates in block diagram form the present system for enhanced caller identification delivery and an environment in which it is operational. In particular, the Public Switched Telephone Network (PSTN) consists of a plurality of Local Exchanges 101, 102 that are interconnected by an Inter-Exchange Network 103. Each of the Local Exchanges 101, 102 provides communication services to a plurality of subscriber lines (112-1 to 112-n & 121-1 to 121-m) and is typically connected to, or includes, a Message Server 111, 112 which functions to provide message services to the plurality of subscribers served by the associated Local Exchange 101, 102.

A Long Distance Network 106 is also connected to the Inter-Exchange Network 103 via an Access Tandem Switch 105 to enable subscribers served by the Local Exchanges 101, 102 to communicate with subscribers served by other Local Exchanges (not shown) and inter-exchange networks (not shown) that are connected to the Long Distance Network 106. Included in the Public Switched Telephone Network is a Signaling Network 104 that interconnects the above-noted systems and which functions to exchange control and signaling messages among these systems. The subscriber lines in the Public Switched Telephone Network can be equipped with caller ID apparatus 113-1, 123-1 which functions, in response to an incoming call being placed to the called subscriber's telephone line, to provide the called subscriber, served by the telephone line, with an indication of the identity of a calling party. This apparatus and the corresponding information delivery service is typically termed “caller ID” and the data displayed to the called subscriber typically consists of the telephone number of the calling party and their name (if available). This caller ID data is originated by the Local Exchange 102 that serves the calling party and is transmitted via the Signaling Network 104 to the Local Exchange 101 that serves the called subscriber's telephone line.

This network architecture is representative of the present communication facilities that serve subscribers and is used to illustrate the operation of the present system for enhanced caller identification delivery, but is not intended to limit the applicability of the present system for enhanced caller identification delivery to other communication network architectures or implementations.

System for Enhanced Caller Identification Delivery

The present system for enhanced caller identification delivery 144 is resident within the Message Server 111, and can be implemented as a process or series of processes that operate with the existing caller ID system to provide delivery of the caller ID data, received from the calling party's Local Exchange 102, to the called subscriber whether the called subscriber is located at their assigned telephone line or at another location. This system also includes the optional capability for the calling party to provide a brief message for transmission to the called subscriber along with the traditional caller ID data. The system for enhanced caller identification delivery 144 is optionally connected to an IP Network 131, such as the Internet, through an IP Network Interface 141 to enable it to exchange messages with other Message Servers 121. A memory 143 is used to store the caller ID data and to maintain a log of the caller ID data transfers that are described herein.

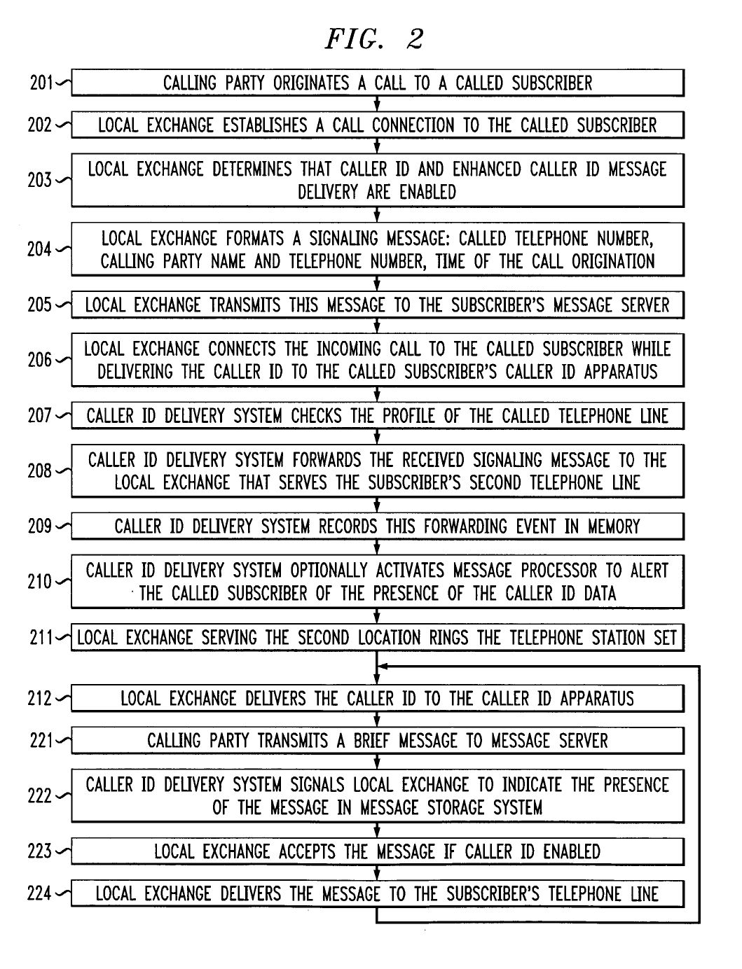

FIG. 2 illustrates in flow diagram form the operation of the present system for enhanced caller identification delivery 144, as implemented in the typical communication network as illustrated in FIG. 1. At step 201, a calling party uses telephone station set 122-m connected to an originating telephone line 124-M on Local Exchange 102, to originate a call to a called subscriber who, for example, is located at a first telephone line 114-1 on Local Exchange 101. The call is extended by controller 102A in Local Exchange 102 through the network 102B to Inter-Exchange Network 103 where the call is routed to Local Exchange 101. When this incoming call arrives at Local Exchange 101, the receipt of the incoming call destined for the called subscriber causes controller 101A of the Local Exchange 101 at step 202 to initiate the final stages of the call connection through network 101B to the called subscriber at telephone line 114-1. In implementing this call connection, the Local Exchange 101 determines at step 203 that caller ID is a feature that is enabled for the called subscriber and enhanced caller ID message delivery is a feature of this service that is also enabled.

At step 204, the Local Exchange 101, in response to the enhanced caller ID message delivery feature being enabled, formats a signaling message that includes a plurality of data, including: the called telephone number, calling party name and telephone number, time of the call origination. Local Exchange 101 transmits this message at step 205 to the Message Server 111 that is associated with or assigned to the called subscriber. The Local Exchange 101 at step 206 also connects the called subscriber's telephone station set 112-1 to the call connection that extends through network 101B to the first telephone line 114-1 and initiates ringing of the telephone station set 112-1 that is connected to the first telephone line 114-1 while delivering the caller ID to the called subscriber's caller ID apparatus 113-1.

The Caller ID Delivery System 144 of the called subscriber's Message Server 111 receives the signaling message from the Signaling Network 104 at step 207 and checks the profile of the called telephone line 114-1 as stored in memory 143 to determine whether the signaling message with its caller ID data should be forwarded to another (second) line number. The identity of the second line number can be input into memory 143 via the Caller ID Delivery System 144 by the called subscriber at a time when the called subscriber knows they are to be at another location, served by the second telephone number, or can be a permanent (or semi-permanent) duplicate called subscriber caller ID data display location (such as a second line for the called subscriber), or can be a call coverage number, and the like. The caller ID data contained in the signaling message is stored by Caller ID Delivery System 144 in memory 143 for possible later retrieval. The second line number typically represents another physical location remote from the called first telephone line 114-1, such as telephone line 124-1 that is served by Local Exchange 102.

The Caller ID Delivery System 144 of Message Server 111 at step 208 forwards the received signaling message to the Local Exchange 102 that serves the second location (telephone line 124-1), records this forwarding event in memory 143 in a log at the Message Server 111 at step 209, and optionally activates message processor 142 at step 210 to alert the called subscriber of the presence of the caller ID data via a voice message, a voice call, a page, SMS message, and the like.

The Local Exchange 102 serving the second location (telephone line 124-1) receives the forwarded signaling message at step 211 and rings the telephone station set 122-1 connected to telephone line 124-1 while delivering the caller ID information to the caller ID apparatus 123-1 that is connected to telephone line 1241 at step 212. The occupants at the second location are thereby alerted to the fact that a call was placed to their other location (telephone line 114-1) and can see the name and number of the calling party. The called subscriber can return the call to the calling party using this information.

The caller ID information can alternatively be accessed by the called subscriber using a WEB browser to view their log as stored in memory 143. The subscriber can use this retrieved caller ID information to return the call.

Another option is for the calling party located at telephone line 124-m to access a WEB interface to transmit a brief message to Message Server 111 for forwarding to the called subscriber's caller ID apparatus 113-1. The calling party uses a WEB browser to access the Message Server 111 via the IP Network 131 and IP Network Interface 141 to enter a brief message and the called subscriber's telephone number into the message storage system 145 at step 221, under the control of the Caller ID Delivery System 144. The Caller ID Delivery System 144 then signals the Local Exchange 101 at step 222, via a signaling message transmitted through Signaling Network 104, to indicate the presence of the message in message storage system 145. Local Exchange 101 at step 223 checks to see whether this telephone number has caller ID enabled and accepts the message if this feature is enabled. Once accepted, the message is delivered to the subscriber's telephone line 114-1 via caller ID at step 224 with a single ring being used to activate the caller ID apparatus 113-1 and to alert the called subscriber that a message has been left in message storage 145 on message system 111.

Summary

The system for enhanced caller identification delivery extends the capabilities of existing caller ID systems by providing delivery of the caller ID data, received from the calling party's Local Exchange, to the called subscriber whether the called subscriber is located at their assigned telephone line or at another location. This system also provides the optional capability for the calling party to provide a brief message for transmission to the called subscriber along with the traditional caller ID data.

What is claimed:

1. A system for delivering caller identification information to a called subscriber who is equipped with a first telephone line that is provisioned with caller ID service, comprising:
message server means, responsive to a call being initiated by a calling party to said called subscriber at said first telephone line, for storing caller ID data, that identifies said calling party, in a memory;
caller identification delivery means for transmitting a message to said subscriber, at a location other than said first telephone line, indicative of receipt of said caller ID data.

2. The system for delivering caller identification information of claim 1 wherein said caller identification delivery means comprises:
caller ID forwarding means for forwarding said stored caller ID data to said called subscriber at a second telephone line.

3. The system for delivering caller identification information of claim 1 wherein said caller identification delivery means comprises:
caller ID alerting means for forwarding a message indicative of the presence of said stored caller ID data to said called subscriber at a second telephone line.

4. The system for delivering caller identification information of claim 1 wherein said caller identification delivery means comprises:
caller ID alerting means for forwarding a message indicative of the presence of said stored caller ID data to said called subscriber.

5. The system for delivering caller identification information of claim 4 wherein said caller identification delivery means further comprises:
caller ID retrieval means, responsive to said called subscriber querying said system for delivering caller identification information, for transmitting said stored caller ID data to said called subscriber.

6. The system for delivering caller identification information of claim 1 further comprising:
message storage means for storing a message received from said calling party; and
wherein said caller identification delivery means is responsive to storage of said calling party message for transmitting a message to said subscriber, at a location other than said first telephone line, indicative of receipt of said calling party message.

7. The system for delivering caller identification information of claim 6 wherein said caller identification delivery means comprises:
calling party message retrieval means, responsive to said called subscriber querying said system for delivering caller identification information, for transmitting said stored calling party message to said called subscriber.

8. A method for delivering caller identification information to a called subscriber who is equipped with a first telephone line that is provisioned with caller ID service, comprising:
storing, in response to a call being initiated by a calling party to said called subscriber at said first telephone line, caller ID data, that identifies said calling party, in a memory;
transmitting a message to said subscriber, at a location other than said first telephone line, indicative of receipt of said caller ID data.

9. The method for delivering caller identification information of claim 8 wherein said step of caller identification delivery comprises:
forwarding said stored caller ID data to said called subscriber at a second telephone line.

10. The method for delivering caller identification information of claim 8 wherein said step of caller identification delivery comprises:
forwarding a message indicative of the presence of said stored caller ID data to said called subscriber at a second telephone line.

11. The method for delivering caller identification information of claim 8 wherein said step of caller identification delivery comprises:
forwarding a message indicative of the presence of said stored caller ID data to said called subscriber.

12. The method for delivering caller identification information of claim 11 wherein said step of caller identification delivery further comprises:
transmitting, in response to said called subscriber initiating a query for said caller identification information, said stored caller ID data to said called subscriber.

13. The method for delivering caller identification information of claim 8 further comprising:
storing a message received from said calling party; and
wherein said step of caller identification delivery is responsive to storage of said calling party message for transmitting a message to said subscriber, at a location other than said first telephone line, indicative of receipt of said calling party message.

14. The method for delivering caller identification information of claim 13 wherein said step of caller identification delivery comprises:
transmitting, in response to said called subscriber initiating a query for said caller identification information, said stored calling party message to said called subscriber.
